(19) United States
(12) Patent Application Publication
(10) Pub. No.: US 2002/0062975 A1
(43) Pub. Date: May 30, 2002

(54) Waterproof structure for a wire harness

(75) Inventor: Takehiro Matsunaga, Yokkaichi-City (JP)

Correspondence Address: GREENBLUM & BERNSTEIN, P.L.C., 1941 ROLAND CLARKE PLACE, RESTON, VA, 20191, US

(73) Assignee: SUMITOMO WIRING SYSTEMS, Ltd., Yokkaichi-City (JP)

(21) Appl. No.: 09/995,715

(22) Filed: Nov. 29, 2001

(30) Foreign Application Priority Data
Nov. 29, 2000 (JP) 2000-362798

(51) Int. Cl. H01B 3/00

(52) U.S. Cl. 174/72 A

(57) ABSTRACT

A waterproof structure applied to a wire harness has a length direction and includes a plurality of electrical cables, each of the electrical cables including a tubular coating and a core made up of plural wires. The electrical cables are respectively stripped of the tubular coating at a same given portion chosen in the length direction of the wire harness, and the cores are exposed. The exposed core wires are adhered to one another by soldering, thereby forming an aggregated external surface. The aggregated external surface is provided with a waterproofing material including an adhering material. That portion of the wire harness corresponding to the aggregated external surface is provided with a bend-prevention device. The waterproof structure of the invention can be applied to a wire harness subjected to frequent bending.

### BACKGROUND OF THE INVENTION

1. Field of the Invention

The present invention generally pertains to a waterproof structure for a wire harness mountable in a vehicle such as an automobile. In particular, the invention concerns a waterproof structure which is resistant to bending stress. The invention also relates to a wire harness including such a waterproof structure. The invention further relates to a method of preparing such a waterproof structure or wire harness.

2. Description of Background Information

Wire harnesses are commonly used for connecting electrical apparatuses to one another in a vehicle such as an automobile. In certain cases, they are mounted in the parts of the vehicle where risk of water contamination is high. In such parts, water tends to penetrate into the wire harness from the periphery of a connector mounted at an end portion of the wire harness. After having penetrated, the water then advances along the wire harness by capillary effect generated between core wires, and reaches the other end portion of the wire harness, where an electronic control unit (ECU) is commonly mounted. The ECU is then liable to damage by water.

As shown in FIG. 1, a vehicle 12 is attached to a trailer 13 through a towing bar or rope, and a wire harness 11 is wired along the trailer 13, so that the turn indicators of the latter can be switched from the vehicle 12. When a jet ski 14 or other water craft is carried on the trailer 13 and unloaded onto water W, the trailer 13 will have to be submerged into the water W.

In such a case, water will be soaked up from the trailer-side harness end into the vehicle-side harness end through the above-mentioned capillary effect. To prevent this from happening, the wire harness may be subjected to a waterproofing treatment, such as described in Japanese Utility Model published under No. HEI 6-86221.

According to the above document, the waterproofing treatment is performed as follows. The electrical cables constituting a wire harness are first stripped of their vinyl tube at a given position chosen in their length direction. Each electrical cable contains a core having a plurality of wires, which are thus exposed, leaving spaces between them. These spaces are filled with waterproofing material, and the external surface of the latter is further wrapped with a waterproof insulator coating. In this manner, the capillary flow of water between the core wires can be stopped at the above-mentioned given position, where the waterproofing material is located.

However, a wire harness, such as one between the vehicle 12 and the trailer 13 as exemplified above, undergoes frequent bending. As a result, the waterproofing structure such as that described above suffers a disintegration between the waterproofing material and the wire cores, or between the waterproof insulator coating and wire cores, thereby forming interstices. Water then enters into and moves along the interstices.

A main object of the present invention is therefore to provide a waterproof structure for a wire harness which is substantially unaffected by frequent bending and thus can be applied to frequently bending parts of a vehicle, without losing its waterproofing ability.

### SUMMARY OF THE INVENTION

To this end, the present invention includes a waterproof structure applicable to a wire harness having a length direction and including a plurality of electrical cables. Each of the electrical cables includes a core and a tubular coating, and each of the cores includes plural wires. The electrical cables are respectively stripped of the tubular coating at a same given portion along the length direction of the wire harness, to expose their cores and the wires thereof.

The wires of an exposed core are adhered to one another, thereby forming an aggregated external surface. The aggregated external surface is provided with a waterproofing material.

The waterproof structure further includes a bend-prevention device extending along at least the aggregated external surface in the length direction of the wire harness.

The waterproofing material may have a substantially tubular shape with an internal circular face, and include an adhering material on the internal circular face, so that the adhering material can be adhered to the aggregated external surface.

The bend-prevention device may include at least one bar made of resin material.

The waterproof structure may be configured for installation on a wire harness wired between a vehicle and a trailer linked thereto.

Another aspect of the present invention includes a wire harness with a waterproof structure, the wire harness having a length direction and including a plurality of electrical cables. Each of the electrical cables includes a core and a tubular coating and each of the cores includes plural wires. The electrical cables are respectively stripped of the tubular coating at a same given portion along the length direction of the wire harness, to expose their cores and the wires thereof.

The wires of an exposed core are adhered to one another, thereby forming an aggregated external surface. The aggregated external surface is provided with a waterproofing material.

The waterproof structure further includes a bend-prevention device extending along at least the aggregated external surface in the length direction of the wire harness.

The waterproofing material may have a substantially tubular shape with an internal circular face, and include an adhering material on the internal circular face, so that the adhering material can be adhered to the aggregated external surface.

The bend-prevention device may include at least one bar made of resin material.

The waterproof structure may be configured for installation on a wire harness wired between a vehicle and a trailer linked thereto.

Another aspect of the present invention includes a method for applying a waterproof structure to a wire harness having a length direction and including a plurality of electrical cables, each of the electrical cables including a core and a tubular coating and each of the cores including plural wires. The method includes stripping the electrical cables respectively of their tubular coating at a same given portion along the length direction of the wire harness, to expose the core and the wires thereof.

Next, the wires of an exposed core are adhered to one another thereby forming an aggregated external surface. The aggregated external surface is provided with a waterproofing material. A bend-prevention device is provided extending along at least the aggregated external surface in the length direction of the wire harness.

In the above method, the waterproofing material provided may be a waterproofing material having a substantially tubular shape with an internal circular face, and an adhering material on the internal circular face, so that the adhering material can be adhered to the aggregated external surface. The bend-prevention device provided may include at least one bar made of resin material. Further, the wires of an exposed core may be adhered to one another by soldering.

According to the above structure of the invention, when water penetrates from one end of the wire harness and moves along to the other end thereof between the wires of a core, its movement is stopped by the waterproof structure where the wires of the core are soldered and wound with the waterproofing material.

Further, the waterproof structure is equipped with bend-preventing material, so that even when the wire harness is subjected to frequent bending, the waterproof structure is prevented from bending, and stays intact. As a simple material is used for avoiding the bending of the waterproof structure, the overall construction costs are drastically reduced.

By virtue of the above simple but efficient protection system, the waterproof structure is no longer vulnerable to repeated bending, and retains its impermeable feature.

### BRIEF DESCRIPTION OF THE DRAWINGS

The above, and the other objects, features and advantages will be made apparent from the following description of the preferred embodiments, given as non-limiting examples, with reference to the accompanying drawings, in which:

FIG. 1A shows a vehicle and a trailer carrying a jet ski, and a wire harness installed therebetween;

FIG. 1B shows how the jet ski is unloaded from the trailer into water;

FIG. 2 shows a wire harness wrapped with a corrugated tube, to which a waterproof structure of the invention is applied;

FIG. 3A is a schematic side view of the waterproof structure according to an embodiment of the invention;

FIG. 3B is a cross-sectional view taken along line A-A in FIG. 3A;

FIG. 4A is a side view of a resin bar according to an embodiment of the invention;

FIG. 4B is a cross-sectional view of the resin bar of FIG. 4A; and

FIG. 5 is a perspective view of a waterproof structure according to another embodiment of the invention.

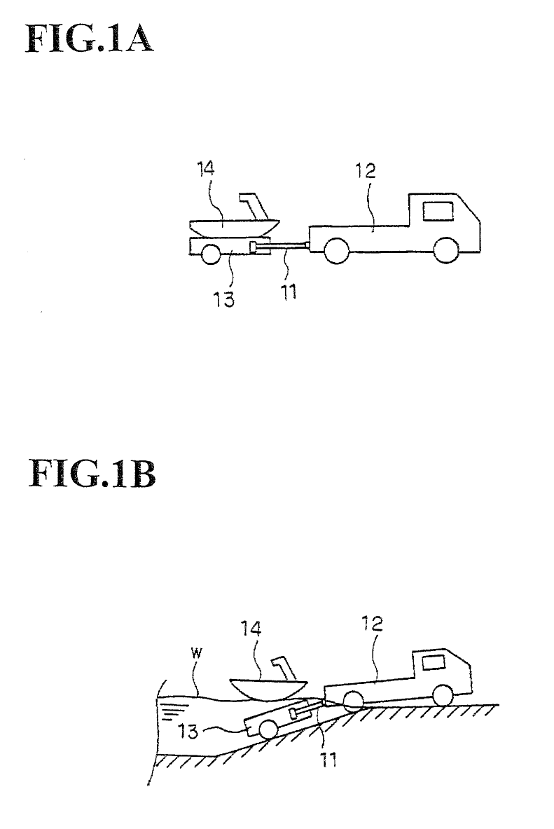

### DETAILED DESCRIPTION OF THE PREFERRED EMBODIMENTS

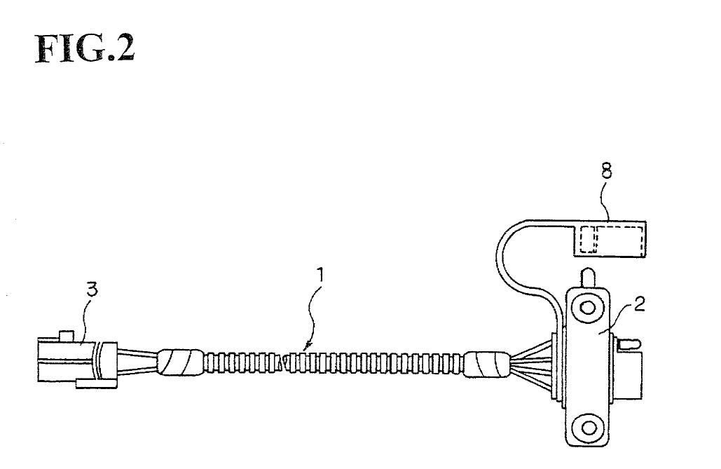

FIG. 2 shows a corrugated tube mounted around a wire harness 1. First and second ends of the wire harness 1 are provided respectively with a first connector 2 and a second connector 3. The first connector 2 is linked to electrical devices in a vehicle (not shown in the figure), whereas the second connector 3 is linked to a trailer (not shown in the figure). One of the electrical devices may, for example, activate the turn indicators of the trailer via the wire harness 1.

The trailer 13 is towed by the vehicle 12 through a traction member made of suitable material, such as metal. The wire harness 1 is wired along this traction member.

The wire harness 1 contains a bundle of electrical cables 4, and each electrical cable 4 is composed of a core 4a made up of plural wires, and a tubular coating 4b. Tubular coating 4b may be made of any suitable material, such as a vinyl tube.

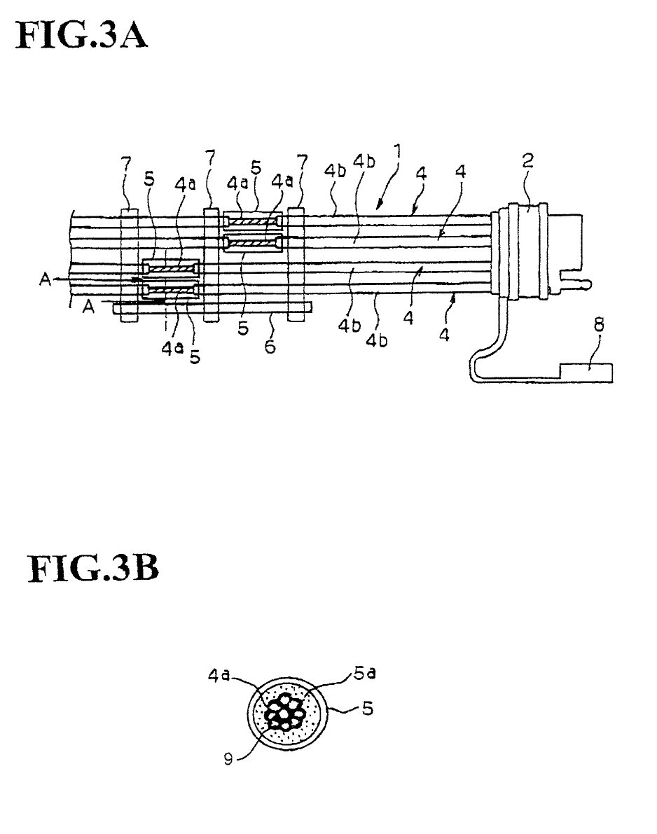

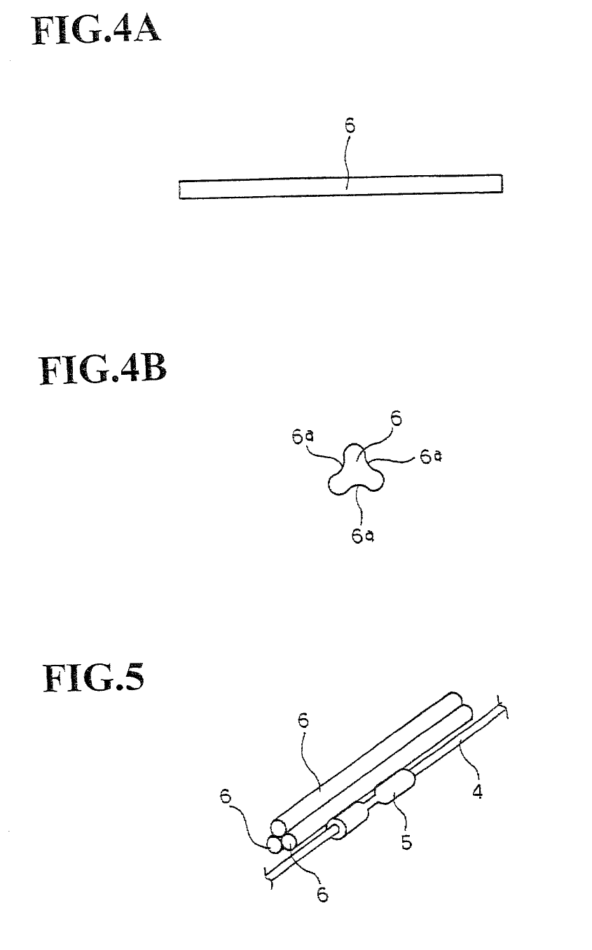

A middle portion of each electrical cable 4 (for example, substantially half way along the length) is stripped of the tubular coating 4b, so as to bare the core 4a. The wires of core 4a are adhered to one another by any suitable process, such as by soldering 9 as shown in FIG. 3B. The extent of the adhered area is shown by hatching in FIG. 3A. The solder fills voids between the wires of a core, and forms an aggregated external surface of the core. The bared and soldered wire cores 4a are wrapped with any suitable waterproofing material, such as a heat-shrinkable tube 5, whose internal circular surface is provided with an adhering material 5a.

The section to which the heat-shrinkable tube 5 is applied is supported by a bar 6 made of any suitable material, such as a resin material. The bar 6 may be formed of a hard vinyl chloride, and firmly fixed along the heat-shrinkable tube 5 by any suitable attachment means, such as a PVC tape 7. The bar 6 made of resin material may be provided with one or several longitudinal recesses 6a, inside each of which extends an electrical cable 4. The bar 6 functions as a bend-prevention device.

The resin bar 6 can prevent electric leakage by virtue of its material characteristics. It also possesses sufficient strength, such that it can prevent flexing of the section where the heat-shrinkable tube 5 is applied. FIG. 2 also shows a protection cap 8 mounted on the first connector 2.

When a vehicle 12 towing a trailer 13 is turned right or left, the wire harness 1 connecting them is often subjected to frequent bending. Further, in circumstances such as unloading a jet ski 14 into water, the trailer 13 must be immersed into the water, imparting a large bending force to the wire harness 1 which could lead to its breakage. The water may then penetrate into the harness, and be soaked up to the vehicle via the wire harness 1.

According to the present embodiment, water soaked up via the cores 4a is stopped from moving further, by virtue of the waterproof structure, in which the wires of a core 4a are soldered and protected by the heat-shrinkable tube 5.

Moreover, the waterproof section is supported by the bar 6, which protects the waterproof structure, even when the harness is subjected to frequent bending.

In the above embodiment, the bend-prevention device is composed of the bar 6 made of resin material. Since the bending of the waterproof structure can be avoided by such a simple means, the waterproof structure can be prepared very economically.

In another embodiment, several bars made of resin material may be used, instead of one single bar 6. When three resin bars are bundled as shown in FIG. 5, the bending of the waterproof structure can be prevented more efficiently.

Further, the waterproofing material is not limited to a heat-shrinkable tube, but could also be in any other suitable form, such as a tape.

As mentioned above, when water penetrates from one end of the wire harness and moves toward the other end thereof between the wires of the cores, its movement is stopped by a waterproof section where the wires of the cores are soldered and covered with the waterproofing material.

Further, the waterproof section is equipped with bend-prevention material, so that even when the wire harness is subjected to frequent bending, the waterproof structure is prevented from bending, and stays intact.

Since the bend-prevention device contains at least one bar made of resin material, the structure is simple and the construction costs are lowered. Nonetheless, the waterproof structure is efficiently prevented from bending and suffering from water penetration.

The waterproof structure of the invention may be applied to a wire harness used under frequent bending conditions, such as one wired on a traction bar between a vehicle and a trailer.

Although the invention has been described with reference to particular means, materials and embodiments, it is to be understood that the invention is not limited to the particulars disclosed and extends to all equivalents within the scope of the claims.

The present disclosure relates to subject matter contained in priority Japanese Application No. 2000-362798, filed on Nov. 29, 2000, which is herein expressly incorporated by reference in its entirety.

What is claimed:

1. A waterproof structure applicable to a wire harness having a length direction and including a plurality of electrical cables, each of the electrical cables including a core and a tubular coating, each of the cores including plural wires, the electrical cables being respectively stripped of the tubular coating at a same given portion along the length direction of the wire harness, to expose the cores and the wires thereof, said waterproof structure comprising:
an aggregated external surface formed by adhering the wires of an exposed core to one another;
a waterproofing material applied to said aggregated external surface; and
a bend-prevention device extending along at least said aggregated external surface in the length direction of said wire harness.

2. The waterproof structure according to claim 1, wherein said waterproofing material has a substantially tubular shape with an internal circular face, and includes an adhering material on said internal circular face, so that said adhering material can be adhered to said aggregated external surface.

3. The waterproof structure according to claim 1, wherein said bend-prevention device comprises at least one bar made of resin material.

4. The waterproof structure according to claim 2, wherein said bend-prevention device comprises at least one bar made of resin material.

5. The waterproof structure according to claim 1, configured for installation on a wire harness wired between a vehicle and a trailer linked thereto.

6. The waterproof structure according to claim 2, configured for installation on a wire harness wired between a vehicle and a trailer linked thereto.

7. The waterproof structure according to claim 3, configured for installation on a wire harness wired between a vehicle and a trailer linked thereto.

8. The waterproof structure according to claim 4, configured for installation on a wire harness wired between a vehicle and a trailer linked thereto.

9. A wire harness with a waterproof structure, the wire harness having a length direction and comprising a plurality of electrical cables, each of the electrical cables including a core and a tubular coating, each of the cores including plural wires, the electrical cables being respectively stripped of the tubular coating at a same given portion along the length direction of the wire harness, to expose the cores and the wires thereof, further comprising:
an aggregated external surface formed by adhering the wires of an exposed core to one another;
a waterproofing material applied to said aggregated external surface; and
a bend-prevention device extending along at least said aggregated external surface in the length direction of said wire harness.

10. The wire harness with a waterproof structure according to claim 9, wherein said waterproofing material has a substantially tubular shape with an internal circular face, and includes an adhering material on said internal circular face, so that said adhering material can be adhered to said aggregated external surface.

11. The wire harness with a waterproof structure according to claim 9, wherein said bend-prevention device comprises at least one bar made of resin material.

12. The wire harness with a waterproof structure according to claim 10, wherein said bend-prevention device comprises at least one bar made of resin material.

13. The wire harness with a waterproof structure according to claim 9, configured for installation between a vehicle and a trailer linked thereto.

14. The wire harness with a waterproof structure according to claim 10, configured for installation between a vehicle and a trailer linked thereto.

15. The wire harness with a waterproof structure according to claim 11, configured for installation between a vehicle and a trailer linked thereto.

16. The wire harness with a waterproof structure according to claim 12, configured for installation between a vehicle and a trailer linked thereto.

17. A method for applying a waterproof structure to a wire harness having a length direction and including a plurality of electrical cables, each of the electrical cables including a core and a tubular coating, each of the cores including plural wires, said method comprising:
stripping the electrical cables respectively of said tubular coating at a same given portion along the length direction of said wire harness, so that said cores and wires thereof are exposed;
adhering the wires of an exposed core to one another, thereby forming an aggregated external surface;
providing said aggregated external surface with a waterproofing material; and
providing a bend-prevention device extending along at least said aggregated external surface in the length direction of said wire harness.

18. The method according to claim 17, wherein said providing of a waterproofing material comprises providing a waterproofing material having a substantially tubular shape with an internal circular face, and providing an adhering material on said internal circular face, so that said adhering material can be adhered to said aggregated external surface.

19. The method according to claim 17, wherein said providing of a bend-prevention device comprises providing a bend-prevention device which includes at least one bar made of resin material.

20. The method according to claim 18, wherein said providing of a bend-prevention device comprises providing a bend-prevention device which includes at least one bar made of resin material.

21. The method according to claim 17, wherein the wires of an exposed core are adhered to one another by soldering.

22. The method according to claim 18, wherein the wires of an exposed core are adhered to one another by soldering.

23. The method according to claim 19, wherein the wires of an exposed core are adhered to one another by soldering.

24. The method according to claim 20, wherein the wires of an exposed core are adhered to one another by soldering.
